(19) United States
(12) Patent Application Publication
(10) Pub. No.: US 2017/0039428 A1
(43) Pub. Date: Feb. 9, 2017

(54) INFORMATION PROCESSING METHOD, INFORMATION PROCESSING APPARATUS, AND NON-TRANSITORY COMPUTER-READABLE STORAGE MEDIUM

(71) Applicant: CANON KABUSHIKI KAISHA, Tokyo (JP)

(72) Inventors: Nobuaki Kuwabara, Yokohama-shi (JP); Satoru Mamiya, Yokohama-shi (JP)

(21) Appl. No.: 15/219,759

(22) Filed: Jul. 26, 2016

(30) Foreign Application Priority Data
Aug. 7, 2015 (JP) 2015-157505

(51) Int. Cl. G06K 9/00

(52) U.S. Cl. CPC G06K 9/00677

(57) ABSTRACT

An information processing method comprises: inputting information of an image group to which one or more of images belong; setting a target range when selecting an image group; if a range identified by the information of the image group input in the inputting straddles a limit of the target range, determining based on the information of the image group and the target range whether to select the image group as an output target candidate; and selecting one or more image groups corresponding to the target range as the output target candidate, in accordance with the determination.

### BACKGROUND OF THE INVENTION

Field of the Invention

The present invention relates to an information processing method, an information processing apparatus, and a non-transitory computer-readable storage medium.

Description of the Related Art

In recent years, there is provided a service for selecting images during a period set by a user from images captured by the user and creating a photobook.

As a method of selecting images in consideration of images outside the period set by the user, there is a method described in Japanese Patent Laid-Open No. 2006-53871. Japanese Patent Laid-Open No. 2006-53871 describes applying “deemed time” to images captured in an event straddling a date. For example, the capturing time of an image in the next day of an event straddling the date, for example, an image captured at 1:00 a.m. is corrected to the date/time of the previous day. That is, Japanese Patent Laid-Open No. 2006-53871 describes a method of correcting the capturing time of the image captured at 1:00 a.m. in the next day to 25:00 in the previous day, thereby handling events straddling the date limit as one group.

In the method described in Japanese Patent Laid-Open No. 2006-53871, the date/time of an event is corrected to the date/time of the previous day independently of the form of the event. For this reason, an image different from user's recognition may be selected depending on the form of the event. For example, assume that in an event to see sunrise, the user starts capturing images in the night of the previous day and captures the sunrise early in the morning of the next day. This event is recognized by the user as the event of the next day because he/she captures the sunrise that is the main occurrence of the event in the next day. If the method of Japanese Patent Laid-Open No. 2006-53871 is applied to this event, the date of an image captured in the event is corrected to the date of the previous day. As a result, for example, if the user designates a date range assuming another event that ended in the start day of the event to see the sunrise, an image of the sunrise captured in the next day is included in the date range without user's intention.

### SUMMARY OF THE INVENTION

The present invention has been made in consideration of the above-described problem, and enables appropriate determination as to whether to select, as an output target candidate, an image group straddling the limit of a target range when selecting an image group.

According to one aspect of the present invention, there is provided an information processing method comprising: inputting information of an image group to which one or more of images belong; setting a target range when selecting an image group; if a range identified by the information of the image group input in the inputting straddles a limit of the target range, determining based on the information of the image group and the target range whether to select the image group as an output target candidate; and selecting one or more image groups corresponding to the target range as the output target candidate, in accordance with the determination.

According to another aspect of the present invention, there is provided an information processing apparatus comprising: an input unit configured to input information of an image group to which one or more images belong; a setting unit configured to set a target range when selecting an image group; a determination unit configured to, if a range identified by the information of the image group input by the input unit straddles a limit of the target range, determine based on the information of the image group and the target range whether to select the image group as an output target candidate; and a selection unit configured to select one or more image groups corresponding to the target range as the output target candidate, in accordance with the determination by the determination unit.

According to another aspect of the present invention, there is provided a non-transitory computer-readable storage medium storing a program that causes a computer to function as: an input unit configured to input information of an image group to which one or more images belong; a setting unit configured to set a target range when selecting an image group; a determination unit configured to, if a range identified by the information of the image group input by the input unit straddles a limit of the target range, determine based on the information of the image group and the target range whether to select the image group as an output target candidate; and a selection unit configured to select one or more image groups corresponding to the target range as the output target candidate, in accordance with the determination by the determination unit.

According to the present invention, it is possible to appropriately determine whether to select, as an output target candidate, an image group straddling the limit of a target range when selecting an image group.

Further features of the present invention will become apparent from the following description of exemplary embodiments (with reference to the attached drawings).

### BRIEF DESCRIPTION OF THE DRAWINGS

FIGS. 1A and 1B are block diagrams showing examples of the arrangement of an image group selection apparatus;

FIG. 2 is a view showing an example of image group information according to the first embodiment;

FIG. 3 is a view showing an example of data of a selection target period according to the first embodiment;

FIG. 4 is a flowchart showing an operation according to the first embodiment;

FIG. 5 is a flowchart of image group selection determination processing according to the first embodiment;

FIG. 6 is a view for explaining a detailed example of image group selection according to the first embodiment;

FIG. 7 is a view for explaining a detailed example of image group selection according to the first embodiment;

FIG. 8 is a flowchart of image group selection determination processing according to the second embodiment;

FIG. 9 is a view showing an example of image group information according to the third embodiment;

FIG. 10 is a flowchart of image group selection determination processing according to the third embodiment;

FIG. 11 is a view showing an example of image group information according to the fourth embodiment;

FIG. 12 is a flowchart of image group selection determination processing according to the fourth embodiment;

FIG. 13 is a block diagram showing an example of the arrangement of an image group selection apparatus according to the fifth embodiment;

FIG. 14 is a view showing a display example of a notification according to the fifth embodiment;

FIG. 15 is a flowchart of image group selection determination processing according to the fifth embodiment;

FIG. 16 is a view for explaining a detailed example of image group selection according to the sixth embodiment;

FIG. 17 is a flowchart of image group selection determination processing according to the sixth embodiment;

FIG. 18 is a view showing an example of image group information according to the seventh embodiment;

FIG. 19 is a view showing an example of data of a selection target region according to the seventh embodiment;

FIG. 20 is a flowchart showing the operation of an image group selection unit according to the seventh embodiment;

FIG. 21 is a view showing the positional relationship between image groups according to the seventh embodiment;

FIG. 22 is a block diagram showing an example of the arrangement of a photobook creation apparatus according to the ninth embodiment; and

FIG. 23 is a flowchart showing the operation of the photobook creation apparatus according to the ninth embodiment.

### DESCRIPTION OF THE EMBODIMENTS

Embodiments of the present invention will now be described in detail with reference to the accompanying drawings.

### First Embodiment

[System Arrangement]

If the capturing period of an image group straddles the limit of a selection target period with respect to the selection target period, an image group selection apparatus according to this embodiment determines whether to select the image group using the length of a section within the selection target period and the length of a section outside the selection target period.

In the following description of the first to sixth embodiments, a section within a selection target period out of the capturing period of an image group will be referred to as “a section within the selection target period”, and a section outside the selection target period out of the capturing period of the image group will be referred to as “a section outside the selection target period”.

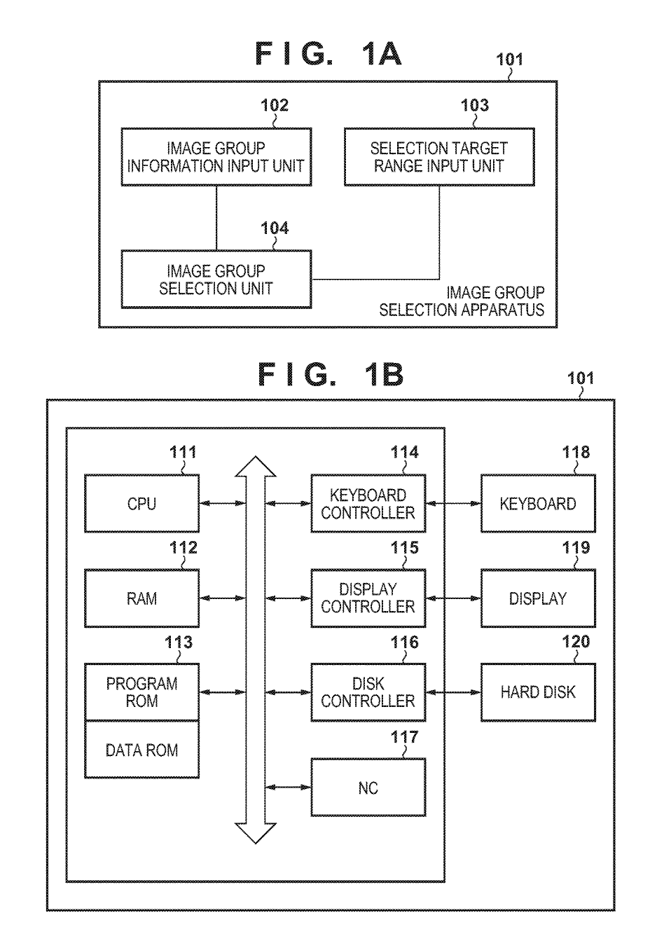

FIG. 1A is a block diagram showing an example of the software configuration of an image group selection apparatus 101 according to this embodiment. The image group selection apparatus 101 includes an image group information input unit 102, a selection target range input unit 103, and an image group selection unit 104. The image group information input unit 102 inputs the information of an image group. The selection target range input unit 103 sets a target range to select an image group. The image group selection unit 104 selects an image group based on the information of the image group input by the image group information input unit 102 and the selection target range input by the selection target range input unit 103.

The method of inputting a range to the selection target range input unit 103 can be set by the user via a UI (User Interface) or set from another apparatus incorporating the image group selection apparatus. In addition, as the above-described range, a time range, that is, a period is used in this embodiment.

FIG. 1B is a block diagram showing an example of the hardware arrangement of the image group selection apparatus 101 that is an information processing apparatus. The image group selection apparatus 101 can be formed by the hardware of a general information processing apparatus. A CPU 111 executes a program stored in the program ROM of a ROM 113 or a program such as an OS (Operating System) or an application loaded from a hard disk 120 to a RAM 112.

That is, the CPU 111 executes a program stored in a readable storage medium, thereby functioning as each unit of the image group selection apparatus 101 shown in FIG. 1A and executing the processing of each flowchart to be described later. The RAM 112 is the main memory of the CPU 111 and functions as a work area or the like. A keyboard controller 114 controls an operation input from a keyboard 118 or a pointing device (for example, a mouse, a touch pad, a touch panel or a trackball) (not shown). A display controller 115 controls display on a display 119. A disk controller 116 controls data access to the hard disk (HD) 120 that stores various kinds of data. A network controller (NC) 117 is connected to a network (not shown) and executes communication control processing with an external apparatus connected to the network.

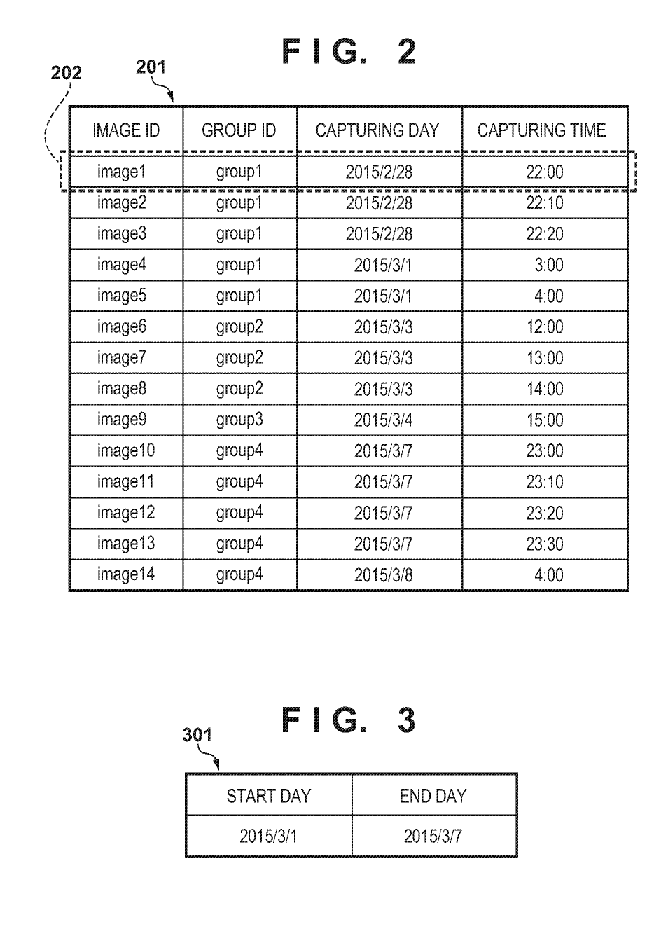

FIG. 2 is a view showing an example of the data structure and actual data of image group information input to the image group information input unit 102. The data structure of image group information is a table format as indicated by a table 201 shown in FIG. 2. One row of the table shown in FIG. 2 represents one image, and the columns of the table shown in FIG. 2 represent information assigned to each image. The items of the columns of the table shown in FIG. 2 are an image ID, group ID, capturing day, and capturing time. Note that the items included in the table are not limited to these and may also include, for example, the position information of the capturing location of an image.

The image ID is an item that assigns a unique identifier to each image. The group ID is an item that assigns a unique identifier representing an image group to each image. When the same group ID is assigned to a plurality of images, the plurality of images can be handled as the same image group. To decide the group ID, a general clustering method can be applied. For example, the group ID may be decided by the Nearest Neighbor method using the difference between the capturing days/capturing times of images as a distance.

The capturing day is an item that assigns the date of image capturing to each image. The capturing time is an item that assigns the time of image capturing to each image. For example, the image of a row 202 shown in FIG. 2 has an image ID “image1” and belongs to an image group of a group ID “group1”. The capturing day of the image is “2015/2/28”, and the capturing time is “22:00”.

FIG. 3 is a view showing an example of the data structure and data of a selection target period input to the selection target range input unit 103. The data structure of a selection target period input to the selection target range input unit 103 is a table format including a start day and an end day, as indicated by 301. For example, the selection target period shown in FIG. 3 is a period from “2015/3/1 0:00” to “2015/3/7 24:00 (3/8 0:00)”.

[Processing Procedure]

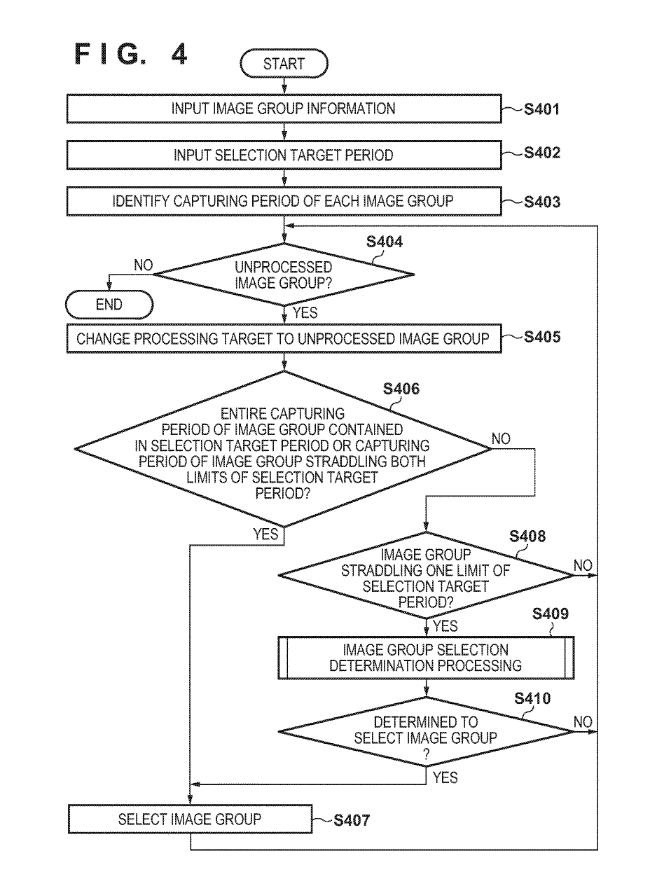

FIG. 4 is a flowchart showing the operation of the image group selection unit 104. This processing procedure is implemented when the CPU provided in the image group selection apparatus 101 reads out and executes a program stored in a storage unit such as the HDD.

In step S401, the image group selection unit 104 accepts input of image group information from the image group information input unit 102. Here, assume that the data shown in FIG. 2 is input.

In step S402, the image group selection unit 104 accepts input of a selection target period from the selection target range input unit 103. Here, assume that the data shown in FIG. 3 is input.

In step S403, the image group selection unit 104 identifies the capturing period of each image group based on the image group information input from the image group information input unit 102. A method of identifying the capturing period of an image group will be described here using the image group of the image group ID “group1” shown in FIG. 2 as an example. In the example of FIG. 2, images belonging to “group1” are five images whose image IDs are “image1”, “image2”, “image3”, “image4”, and “image5”.

The capturing period of an image group is formed from a start date/time and an end date/time. The capturing date/time of the image with the earliest capturing time out of the images belonging to the image group is defined as the start date/time of the capturing period of the image group, and the latest image capturing date/time is defined as the end date/time of the capturing period of the image group. Hence, in the example shown in FIG. 2, the capturing period of the image group of the group ID “group1” is a period from “2015/2/28 22:00” to “2015/3/1 4:00”.

In addition, as for the capturing period of the image group of the group ID “group3” in FIG. 2, the image of the latest capturing time equals the image of the earliest capturing time (here, 2015/3/4 15:00) because the image group includes only one image. In this embodiment, if one image belongs to an image group, the capturing period of the image group is obtained by setting the start date/time to the capturing date/time and the end date/time to a date/time obtained by adding 1 sec to the capturing date/time. Note that the time added to the capturing period for the image group including only one image may be another unit time.

In step S404, the image group selection unit 104 determines whether an unprocessed image group exists. If an unprocessed image group does not exist (NO in step S404), this processing procedure ends. If an unprocessed image group exists (YES in step S404), the process advances to step S405.

In step S405, the image group selection unit 104 switches one image group out of the unprocessed image groups to the processing target.

In step S406, the image group selection unit 104 determines whether the entire capturing period of the image group is contained in the selection target period or the capturing period of the image group straddles both the limit at the start point and the limit at the end point of the selection target period. If one of the conditions is met (YES in step S406), the process advances to step S407. Otherwise (NO in step S406), the process advances to step S408.

In step S407, the image group selection unit 104 selects the image group of the current processing target as an output target candidate, and the process returns to step S404.

In step S408, the image group selection unit 104 determines whether the capturing period of the image group of the processing target straddles one of the two limits of the selection target period. If the capturing period straddles one of the limits (YES in step S408), the process advances to step S409. Otherwise (NO in step S408), the process returns to step S404.

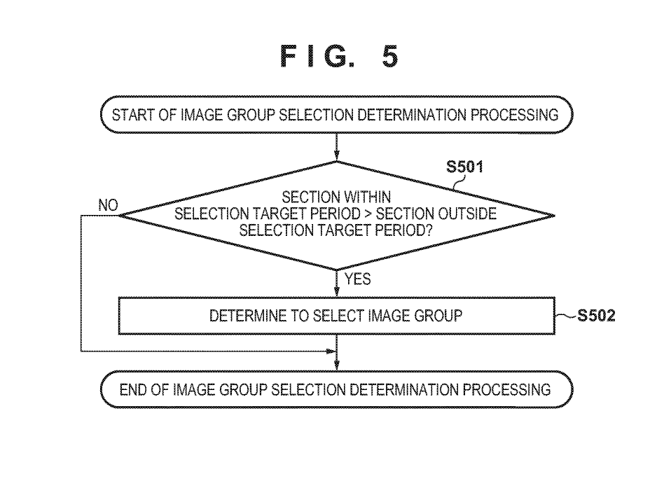

In step S409, the image group selection unit 104 performs image group selection determination processing and then advances to step S410. Details of the process of step S409 will be described later with reference to FIG. 5.

In step S410, the image group selection unit 104 determines whether it is determined by the processing of in step S409 to select the image group of the processing target. Upon determining to select the image group (YES in step S410), the process advances to step S407. Otherwise (NO in step S410), the process returns to step S404.

By the processing shown in FIG. 4, one or more image groups as output target candidates are selected. The CPU 111 outputs images included in the one or more image groups selected in this way. The CPU 111 may output the images to, the display 119 to display the images or output the images to a printing apparatus (not shown) to print the images. The CPU 111 may lay out the images included in the one or more image groups on a predetermined template and output the template with the images laid out. The CPU 111 may further narrow down output target images from a plurality of images included in the one or more image groups selected in the above-described way. For example, images with little blur and defocus may be selected out of the one or more image groups. Alternatively, an important person who appears many times in the one or more of image groups may automatically be analyzed, and images including the important person may be selected. Almost the same number of images may be selected from the one or each of the plurality of image groups. In this case, images are selected without unevenness in the groups. For this reason, when, for example, printing a photobook in which a plurality of images are arranged on a template, images are selected from a plurality of events without unevenness. Hence, an appropriate photobook can be printed.

FIG. 5 is a flowchart showing details of image group selection determination processing in step S409 of FIG. 4 according to this embodiment.

In step S501, the image group selection unit 104 identifies, for the image group of the processing target, the length of the section within the selection target period and the length of the section outside the selection target period. The image group selection unit 104 then determines whether the section within the selection target period is longer than the section outside the selection target period. If the section within the selection target period is longer (YES in step S501), the process advances to step S502. Otherwise (NO in step S501), the processing procedure ends. Details of the processing of step S501 will be described later.

In step S502, the image group selection unit 104 determines to select the image group of the processing target. Then, the processing procedure ends.

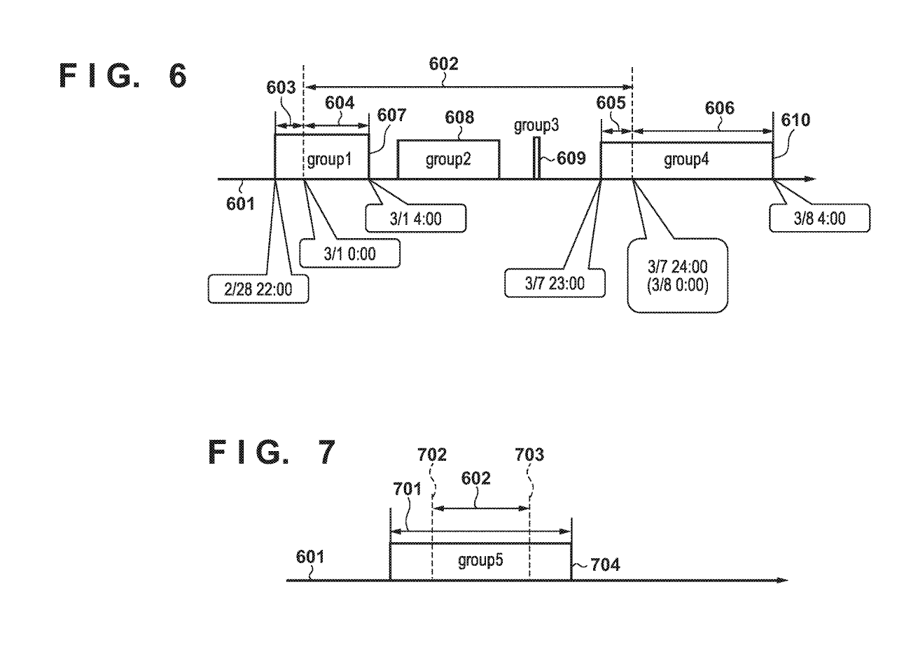

FIG. 6 is a conceptual view showing the relationship between the image group information shown in FIG. 2 and the selection target period shown in FIG. 3.

Image groups 607 to 610 are arranged on a time base 601. The image groups 607 to 610 correspond to the group IDs group1 to group4 in the table 201 shown in FIG. 2, respectively.

The width of each of the image groups 607 to 610 in the direction of the time base 601 represents the capturing period of the image group. A selection target period 602 is a selection target period input from the selection target range input unit 103. The selection target period is a period from the start day to the end day in the table 301 shown in FIG. 3, that is, a period from “2015/3/1 0:00” to “2015/3/7 24:00 (3/8 0:00)”.

Sections 603 and 604 shown on the rectangle of the image group 607 (group1) are sections obtained by dividing the capturing period of the image group 607 (group1). The sections 603 and 604 are divided at the start time of the selection target period 602 and defined as the section 603 outside the selection target period and the section 604 within the selection target period. Similarly, sections 605 and 606 shown on the rectangle of the image group 610 (group4) are defined as the section 605 within the selection target period and the section 606 outside the selection target period.

A case in which the processing shown in FIG. 4 is performed for the image group 607 (group1) to the image group 610 (group4) will be described. The processes of steps S401 to S405 are common to the image groups, and a description thereof will be omitted.

The image group 607 (group1) will be described first. In step S406, it is determined for the image group 607 (group1) that the entire capturing period of the image group is not contained in the selection target period, and the capturing period of the image group does not straddle both the two limits of the selection target period, and the process advances to step S408.

In step S408, it is determined for the image group 607 (group1) that the capturing period of the image group straddles one of the limits between the inside and the outside of the selection target period, and the process advances to step S409 (FIG. 5).

In the capturing period of the image group 607 (group1), the section within the selection target period is the section 604, and the section outside the selection target period is the section 603. The section 603 outside the selection target period is 2 hrs because it ranges from 2/28 22:00 to 3/1 0:00. The section 604 within the selection target period is 4 hrs because it ranges from 3/1 0:00 to 4:00.

In step S501 of the image group selection determination processing, when the section 603 outside the selection target period and the section 604 within the selection target period are compared, the section 604 within the selection target period is longer. Hence, in the example of the image group 607 (group1), the process advances to step S502 to determine to select this image group. After the end of the image group selection determination processing in step S409, the process advances to step S410. In steps S410 and S407, the image group 607 (group1) of the processing target is selected, and the process then returns to step S404.

The image groups 608 (group2) and 609 (group3) will be described next. In step S406, it is determined that the entire capturing periods of the image groups 608 (group2) and 609 (group3) are contained in the selection target period 602. In step S407, these image groups are selected, and the process returns to step S404.

The image group 610 (group4) will be described. Like the image group 607 (group1), the image group 610 (group4) is determined to have a capturing period straddling one of the two limits of the selection target period, and the process advances to step S409 (FIG. 5).

In the capturing period of the image group 610 (group4), the section within the selection target period is the section 605, and the section outside the selection target period is the section 606. The section 605 within the selection target period is 1 hr because it ranges from 3/7 23:00 to 3/7 24:00 (3/8 0:00). The section 606 outside the selection target period is 4 hrs because it ranges from 3/7 24:00 (3/8 0:00) to 3/8 4:00.

In step S501 of the image group selection determination processing, the section 605 within the selection target period and the section 606 outside the selection target period are compared, the section 606 outside the selection target period is longer. Hence, in the example of the image group 610 (group4), it is not determined to select the image group 610 (group4), and the image group selection determination processing ends. Since it is not determined to select the target image group, the process returns to step S404 without selecting the image group 610 (group4).

FIG. 7 is a conceptual view showing the relationship between the capturing period of an image group and the selection target period. An example in which the capturing period of an image group 704 (group5) straddles both the limits at the start point and the end point of the selection target period is shown. In this case, the selection target period is contained in the capturing period of the image group 704.

The image group 704 (group5) is arranged on the time base 601. The selection target period 602 is illustrated as well. In addition, a capturing period 701 of the image group 704 (group5) is shown. The capturing period 701 straddles both a limit 702 at the start of the selection target period 602 and a limit 703 at the end of the selection target period 602.

The image group 704 (group5) shown in FIG. 7 will be described. The processes up to step S406 are the same as those for the image groups of other examples, and a description thereof will be omitted. In step S406, it is determined that the capturing period of the image group 704 (group5) shown in FIG. 7 straddles both the two limits at the start point and the end point of the selection target period. Hence, the image group is selected in step S407, and the process returns to step S404.

With the above-described arrangement, an image group whose section within the selection target period is longer than the section outside the selection target period in the set selection target period is selected. It is therefore possible to select an image group close to user's intention.

### Second Embodiment

In this embodiment, if the capturing period of an image group straddles the limit of a selection target period with respect to the set image group selection target period, the number of images captured in the section within the selection target period and the number of images captured in the section outside the selection target period are compared.

An arrangement according to this embodiment is the same as that of the image group selection apparatus according to the first embodiment except the operation of an image group selection unit 104, and a description thereof will be omitted. In addition, the operation of the image group selection unit 104 according to this embodiment is the same as in the first embodiment except image group selection determination processing (step S409 of FIG. 4), and a description thereof will be omitted.

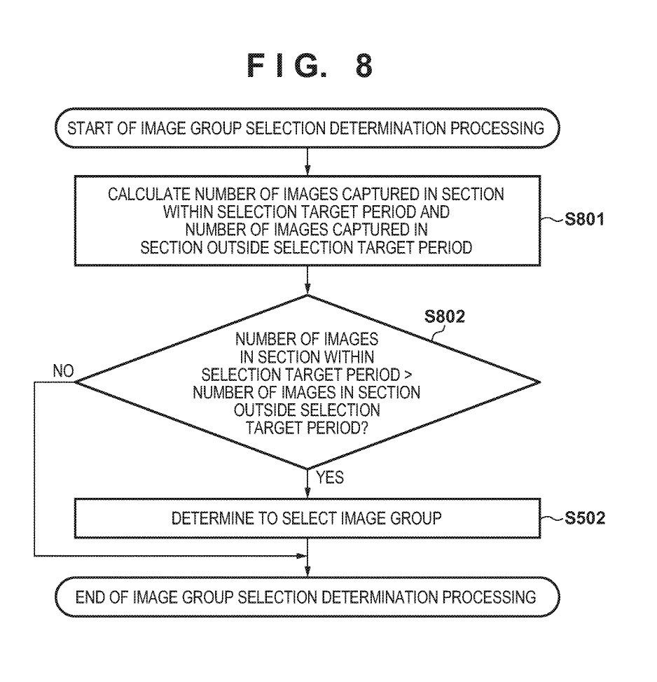

FIG. 8 is a flowchart of image group selection determination processing according to this embodiment.

In step S801, concerning the image group of the processing target, the image group selection unit 104 calculates the number of images captured in the section within the selection target period and the number of images captured in the section outside the selection target period.

In step S802, the image group selection unit 104 compares the number of images captured in the section within the selection target period and the number of images captured in the section outside the selection target period which are calculated in step S801. If the number of images captured in the section within the selection target period is larger than the number of images captured in the section outside the selection target period (YES in step S802), the process advances to step S502. Otherwise (NO in step S802), the image group selection determination processing ends. Step S502 is the same as in the first embodiment, and a description thereof will be omitted.

The image group selection determination processing shown in FIG. 8 will be described in detail with reference to FIG. 6. The target of the image group selection determination processing shown in FIG. 8 is an image group determined by the process of step S408 to have a capturing period straddling one of the two limits of the selection target period. Hence, an image group 607 (group1) and an image group 610 (group4), each of which is an image group whose capturing period straddles one of the limits of the selection target period, will be described.

The image group 607 (group1) will be described first. In step S801, the number of images captured in a section 604 within the selection target period and the number of images captured in a section 603 outside the selection target period are calculated by referring to a table 201 of image group information shown in FIG. 2. As a result of calculation, the number of images captured in the section 604 within the selection target period is 2, and the number of images captured in the section 603 outside the selection target period is 3.

In step S802, the number of images captured in the section 604 within the selection target period is compared with the number of images captured in the section 603 outside the selection target period. As a result, since the number of images captured in the section 603 outside the selection target period is larger than the number of images captured in the section 604 within the selection target period, the image group selection determination processing ends.

The image group 610 (group4) will be described next. In step S801, the number of images captured in a section 605 within the selection target period and the number of images captured in a section 606 outside the selection target period are calculated by referring to the table 201 shown in FIG. 2. The number of images captured in the section 605 within the selection target period is 4, and the number of images captured in the section 606 outside the selection target period is 1.

In step S802, the number of images captured in the section 605 within the selection target period is compared with the number of images captured in the section 606 outside the selection target period. As a result, since the number of images captured in the section 605 within the selection target period is larger, in the example of the image group 610, it is determined in step S502 to select the image group of the processing target.

With the above-described arrangement, an image group in which the number of images captured in the section within the selection target period is larger than the number of images captured in the section outside the selection target period in the set selection target period is selected. It is therefore possible to select an image group close to user's intention.

### Third Embodiment

In this embodiment, the type information of an image group is evaluated for an image group straddling the limit of a selection target period.

An arrangement according to this embodiment is different from the image group selection apparatus explained in the first embodiment in image group information input by an image group information input unit 102 and the operation of an image group selection unit 104. Hence, the image group information input by the image group information input unit 102 and the operation of the image group selection unit 104 will be described.

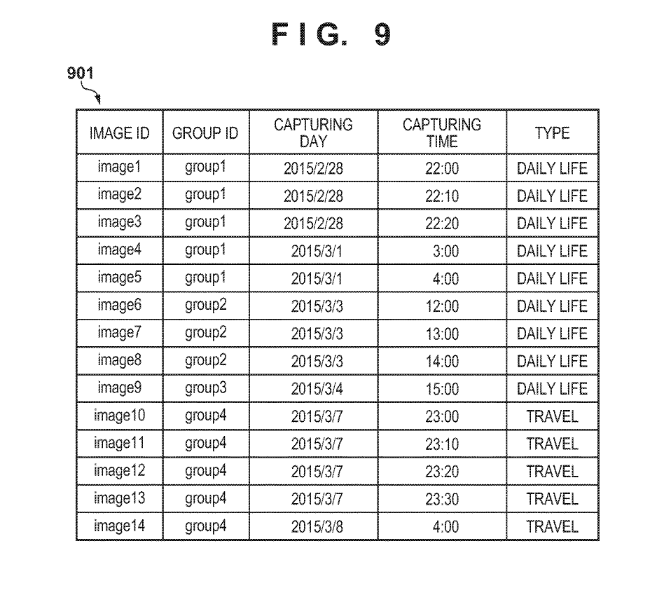

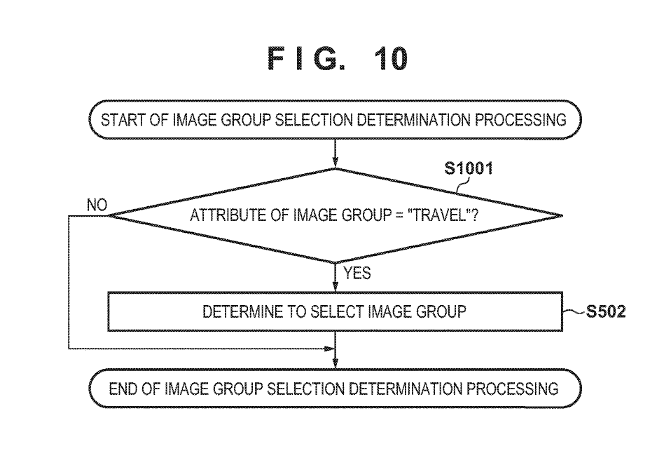

FIG. 9 is a view showing an example of the data structure and data of image group information input by the image group information input unit 102. The data structure of image group information according to this embodiment is a table format as indicated by a table 901 shown in FIG. 9. One row of the table 901 represents one image, and the columns of the table 901 represent information assigned to each image. The items of the columns of the table 901 are an image ID, group ID, capturing day, capturing time, and type. The image ID, group ID, capturing day, and capturing time out of the items of the columns of the table 901 are the same as in the table 201 shown in FIG. 2 described in the first embodiment, and a description thereof will be omitted.

In the table 901, as the item of type, type information is assigned for each group ID. The type can be, for example, an event type such as daily life or travel or the information of a person included in an image group, for example, a son plays the lead role or the father plays the lead role. The type may be assigned by manual input of the user, or automatically selected and assigned by an information processing apparatus or the like from type information defined in advance after recognizing a person or object included in an image.

The operation of the image group selection unit 104 according to this embodiment is the same as in the first embodiment except image group selection determination processing (step S409 of FIG. 4), and a description thereof will be omitted.

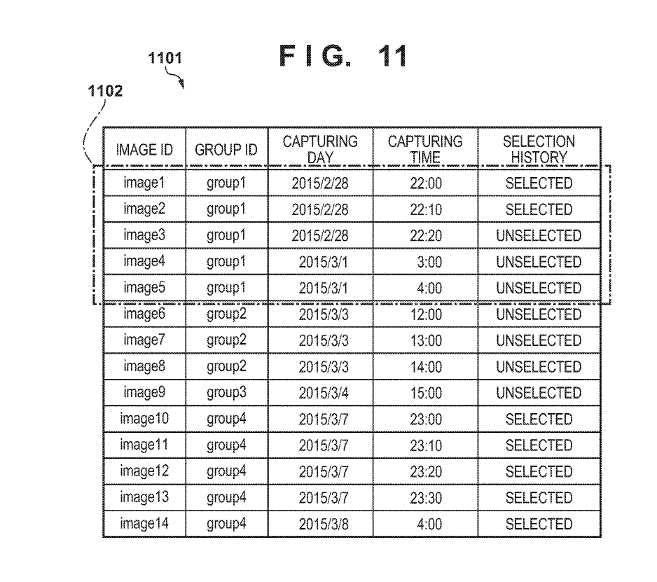

FIG. 10 is a flowchart of image group selection determination processing according to this embodiment.

In step S1001, the image group selection unit 104 determines whether the type of an image group of a processing target is “travel”. If the type is “travel” (YES in step S1001), the process advances to step S502. Otherwise (NO in step S1001), the processing procedure ends. Step S502 is the same as in the first embodiment, and a description thereof will be omitted.

Note that in this embodiment, a condition that the type of an image group is “travel” is set as the determination target in step S1001. However, a condition that the type of an image group is “daily life” may be set, or a condition that the type of an image group is “a son plays the lead role” may be set. Any type that the user considers important is set. The number of types to be determined is not limited to 1, and a plurality of conditions (types) may be determined.

With the above-described arrangement, an image group of a type that the user considers important can be selected by evaluating the type information of an image group for each image group straddling the limit of the selection target period. It is therefore possible to select an image group close to user's intention.

### Fourth Embodiment

In this embodiment, the selection history of an image included in an image group is evaluated for an image group straddling the limit of a selection target period, and the presence/absence of selection is determined based on the evaluation result.

An arrangement according to this embodiment is different from the image group selection apparatus explained in the first embodiment in image group information input by an image group information input unit 102 and the operation of an image group selection unit 104. Hence, the image group information input by the image group information input unit 102 and the operation of the image group selection unit 104 will be described.

FIG. 11 is a view showing an example of the data structure and data of image group information input by the image group information input unit 102. The data structure of image group information according to this embodiment is a table format as indicated by a table 1101 shown in FIG. 11. One row of the table 1101 represents one image, and the columns of the table 1101 represent information assigned to each image. The items of the columns of the table 1101 are an image ID, group ID, capturing day, capturing time, and selection history. The image ID, group ID, capturing day, and capturing time out of the items of the columns of the table 1101 are the same as in the table 201 shown in FIG. 2 described in the first embodiment, and a description thereof will be omitted.

In the table 1101, as the item of selection history, selection history information representing “selected” or “unselected” is assigned to each image. The value of the selection history information is changed in accordance with the past execution of an image group selection apparatus 101. An image selected by the past execution of the image group selection apparatus 101 is “selected”. An image that is not selected by the previous execution of the image group selection apparatus is “unselected”. The initial value is “unselected” here. Note that the selection history may be changed from “unselected” to “selected” by causing the user to manually select an image. Alternatively, the selection history may be changed from “unselected” to “selected” based on a result of image selection by another apparatus. A frame 1102 indicates images having a group ID “group1”.

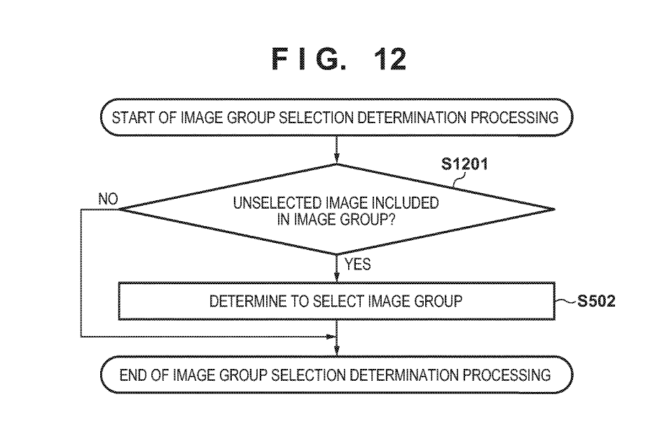

The operation of the image group selection unit 104 according to this embodiment is the same as in the first embodiment except image group selection determination processing (step S409 of FIG. 4), and a description thereof will be omitted. FIG. 12 is a flowchart of image group selection determination processing according to this embodiment.

In step S1201, the image group selection unit 104 determines whether an image group includes an “unselected” image. If an “unselected” image is included (YES in step S1201), the process advances to step S502. Otherwise (NO in step S1201), the processing procedure ends. Step S502 is the same as in the first embodiment, and a description thereof will be omitted.

Note that in this embodiment, a condition that an image group is selected if images included in the image group include at least one unselected image is set in the determination of step S1201. However, a condition that an image group is selected in accordance with the ratio of unselected images included in the image group may be set. An example is a case in which the ratio of unselected images to images included in an image group exceeds ½. The ratio may be set by the user, or a ratio defined in advance may be used.

A condition may be set such that an image group is selected when the number of unselected images included in it is larger than a threshold. The threshold may be set by the user, or a threshold defined in advance may be used. When a threshold is used, it may be set in accordance with the number of images belonging to an image group.

Alternatively, if an evaluation value is assigned to each image included in an image group, a condition may be set such that the image group is selected when an image that is unselected and has an evaluation value equal to or more than a threshold is included. The threshold in this case may be decided in accordance with the evaluation item.

The information “selected” or “unselected” is assigned on an image basis. However, the embodiment is not limited to this, and the information may be assigned on an image group basis.

The image group selection determination processing shown in FIG. 12 will be described in detail with reference to FIG. 6. An image group 607 (group1) shown in FIG. 6 will be described. Since images included in the image group 607 (group1) include unselected images based on the item of the image selection history in the frame 1102 shown in FIG. 11 (YES in step S1201), it is determined in step S502 to select the image group 607 (group1).

With the above-described arrangement, an image group including an image that is unselected in the previous processing can be selected. As a result, unselected images are sequentially selected, and the number of images remaining unselected can be reduced. It is therefore possible to select an image group close to user's intention.

### Fifth Embodiment

In this embodiment, if an image group straddling the limit of a selection target period exists, the user is notified of it.

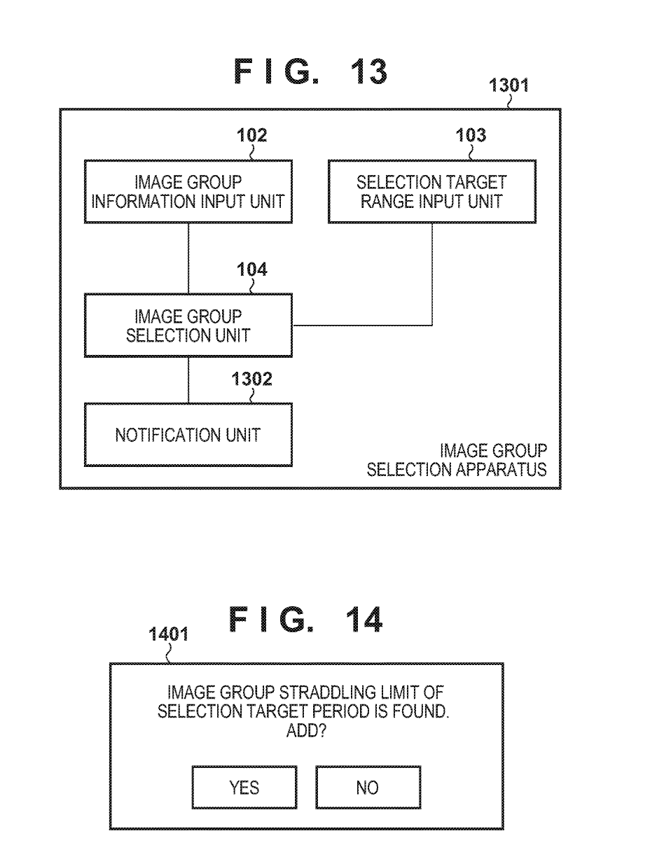

FIG. 13 shows the software configuration of an image group selection apparatus 1301 according to this embodiment. Note that the hardware arrangement is the same as that shown in FIG. 1B of the first embodiment.

The image group selection apparatus 1301 according to this embodiment includes a notification unit 1302 in addition to an image group information input unit 102, a selection target range input unit 103, and an image group selection unit 104 which have been described in the first embodiment. Upon receiving a notification instruction from the image group selection unit 104, the notification unit 1302 notifies the user of it. As for the notification method, for example, the notification unit 1302 notifies the user using a display 119 connected to the image group selection apparatus 1301.

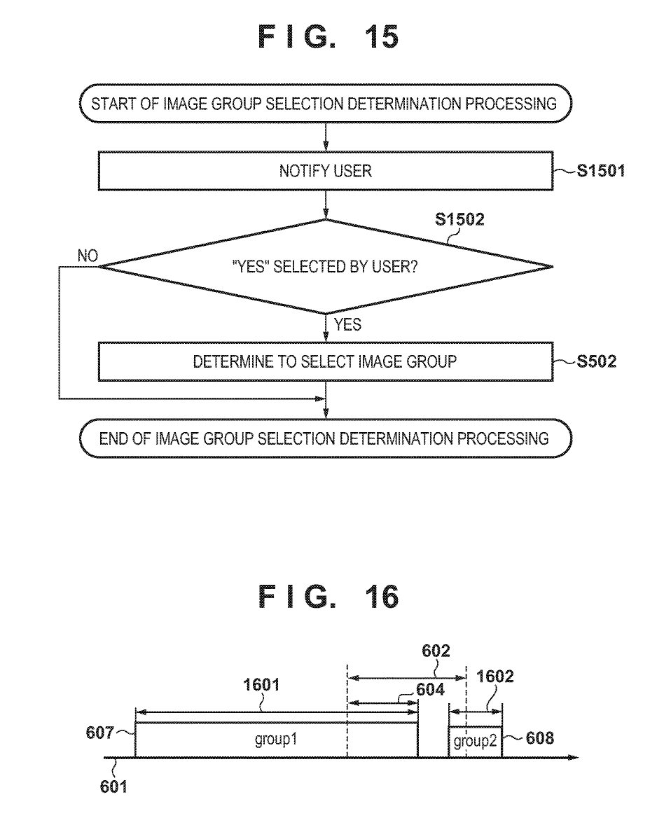

FIG. 14 is a view showing an example of the display image of a notification output from the notification unit 1302 which is displayed on the display 119. A message box 1401 is configured to ask for user's decision as to whether or not to add an image group upon finding an image group straddling the limit of the selection target period. Via the message box 1401, the user can select whether to select and add the image group using buttons “Yes” and “No”. The notification unit 1302 outputs the result selected by the user to the image group selection unit 104. Detailed information of the image group straddling the limit may be notified together.

The image group information input unit 102 and the selection target range input unit 103 are the same as in the first embodiment, and a description thereof will be omitted. The operation of the image group selection unit 104 according to this embodiment is the same as in the first embodiment except image group selection determination processing (step S409 of FIG. 4), and a description thereof will be omitted.

FIG. 15 is a flowchart of image group selection determination processing according to this embodiment.

In step S1501, the image group selection unit 104 outputs a notification instruction to the notification unit 1302. The notification unit 1302 displays the message box 1401 on the display 119 and accepts user selection. When the user inputs an instruction via the message box 1401, the notification unit 1302 outputs the user selection result to the image group selection unit 104.

In step S1502, the image group selection unit 104 determines based on the user selection result output from the notification unit 1302 whether the user selects “Yes”. If the user selects “Yes” (YES in step S1502), the process advances to step S502. If the user selects No (NO in step S1502), the processing procedure ends. Step S502 is the same as in the first embodiment, and a description thereof will be omitted.

With the above-described arrangement, when an image group straddling the limit of the selection target period exists, the user directly determines whether to select the image group. It is therefore possible to select an image group close to user's intention.

### Sixth Embodiment

In this embodiment, processing assuming a case in which the capturing period of an image group straddles the limit of a selection target period and is much longer than the selection target period is performed. In this embodiment, such an image group is divided into a section within the selection target period and a section outside the selection target period, each section is reassigned as an image group, and the image group in the section within the selection target period is selected.

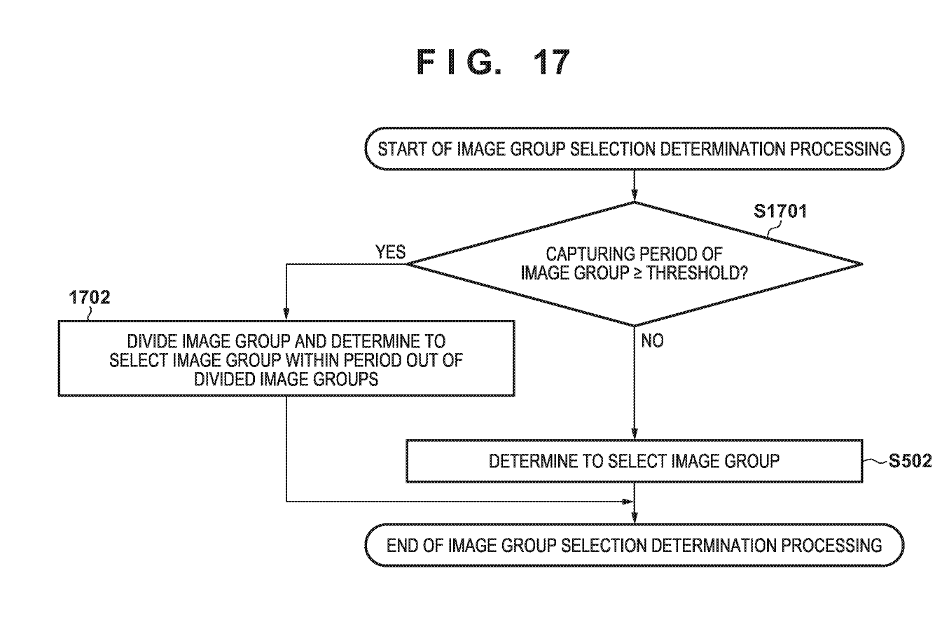

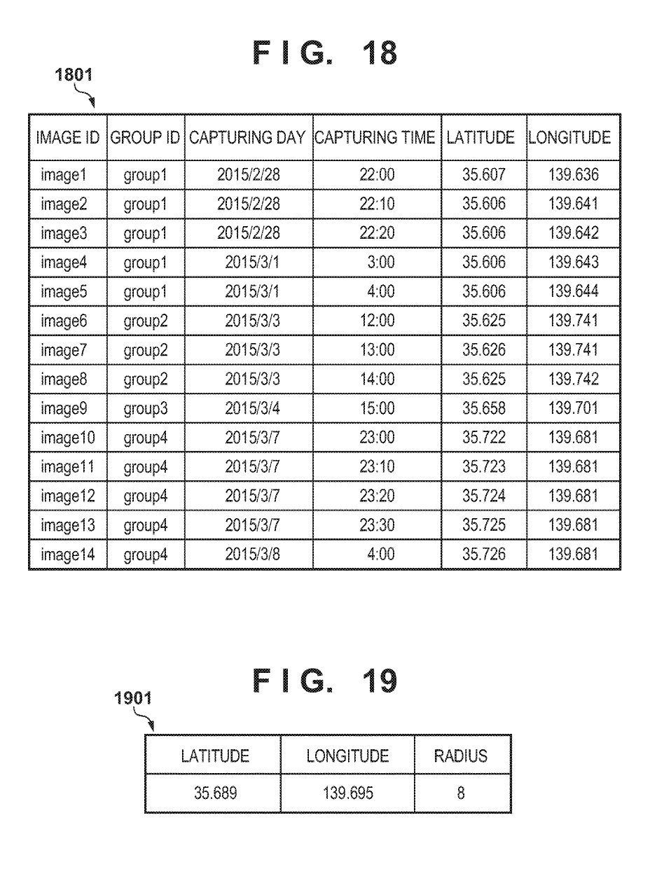

An arrangement according to this embodiment is different from the image group selection apparatus described in the first embodiment in the operation of an image group selection unit 104. FIG. 17 is a flowchart of image group selection determination processing according to this embodiment.

In step S1701, the image group selection unit 104 determines whether the capturing period of an image group of a processing target is equal to or more than a predetermined threshold. If the capturing period is equal to or more than the predetermined threshold (YES in step S1701), the process advances to step S1702. If the capturing period is less than the threshold (NO in step S1701), the process advances to step S502. The threshold in this embodiment is twice longer than a selection target period 602. Note that the threshold may be decided based on the selection target period so as to be twice longer than a selection target period or may be a fixed value. The threshold may be set by the user.

In step S1702, the image group selection unit 104 divides the image group of the processing target into the section within the selection target period and the section outside the selection target period, and reassigns an image group ID to each section. As for the image group ID assigned to each section in the reassignment, for example, if the image group is “group1”, a number is added to the end so that “group1-1” is assigned to the section within the selection target period, and “group1-2” is assigned to the section outside the selection target period. In addition, the group ID of image group information input to the image group selection unit 104 is rewritten from “group1” to “group1-1” for the section within the selection target period and “group1-2” for the section outside the selection target period. The image group selection unit 104 determines to select the image group in the section (group1-1) within the selection target period, and ends the processing procedure.

Step S502 is the same as in the first embodiment, and a description thereof will be omitted. Note that all image groups whose capturing periods are determined to be less than the threshold in step S1701 are selected in step S502 of this embodiment. However, to select an image group closer to user's intention, one of the image group selection determination processes described in the first to fifth embodiments may be performed in step S502.

FIG. 16 is a conceptual view showing the relationship between the capturing period of an image group and the selection target period according to this embodiment. Image groups 607 (group1) and 608 (group2) are arranged on a time base 601. The capturing periods of the image groups are capturing periods 1601 and 1602. In addition, the selection target period 602 and a section 604 of the image group 607 (group1) within the selection target period are illustrated.

The processes of steps S1701 and S1702 will be described in detail with reference to FIG. 16. The image group 607 (group1) shown in FIG. 16 will be described first. In step S1701, the image group selection unit 104 evaluates whether the capturing period 1601 of the image group 607 (group1) is equal to or more than a threshold. In this embodiment, a value twice longer than the selection target period 602 is set as the threshold.

Since the capturing period 1601 of the image group 607 (group1) is equal to or more than the threshold, in step S1702, the image group selection unit 104 divides the image group into the section within the selection target period and the section outside the selection target period, and reassigns an image group ID to each section. The image group selection unit 104 assigns “group1-1” to the section within the selection target period and “group1-2” to the section outside the selection target period. The image group selection unit 104 also rewrites the group ID of input image group information to the reassigned image group IDs. The image group selection unit 104 determines to select “group1-1” that is the image group ID reassigned to the section within the selection target period.

The image group 608 (group2) shown in FIG. 16 will be described next. In step S1701, the image group selection unit 104 evaluates whether the capturing period 1602 of the image group 608 (group2) is equal to or more than the threshold. Since the capturing period 1602 of the image group 608 (group2) is less than the threshold, in step S502, the image group selection unit 104 determines to select the image group 608 (group2).

With the above-described arrangement, if the capturing period of an image group is much longer than the selection target period, it is determined that concerning the image group, the user has an intention to select only the section within the selection target period, and only the section of the image group within the selection target period is selected. It is therefore possible to select an image group close to user's intention.

### Seventh Embodiment

In this embodiment, if the capturing region of an image group straddles the limit of a selection target region with respect to the set selection target region, whether to select the image group is determined using the size of a portion within the selection target region and the size of a portion outside the selection target region.

In the following description of the seventh embodiment, a portion within the selection target region out of the capturing region of an image group will be referred to as “a portion within the selection target region”, and a portion outside the selection target region out of the capturing region of the image group will be referred to as “a portion outside the selection target region”.

An arrangement according to this embodiment is the same as the image group selection apparatus 101 described in the first embodiment. This embodiment is different from the first embodiment in that information input by an image group information input unit 102, information input by an selection target range input unit 103, and the operation of an image group selection unit 104.

FIG. 18 is a view showing an example of the data structure and data of image group information input by the image group information input unit 102. The data structure of image group information is a table format as indicated by a table 1801 shown in FIG. 18. One row of the table 1801 represents one image, and the columns of the table 1801 represent information assigned to each image. The items of the columns of the table 1801 shown in FIG. 18 are an image ID, group ID, capturing day, capturing time, latitude, and longitude. The image ID, group ID, capturing day, and capturing time are the same as in the table 201 shown in FIG. 2 described in the first embodiment, and a description thereof will be omitted. In the table 1801 shown in FIG. 18, position information of an image is assigned as the items of latitude and longitude. A north latitude and an east longitude are expressed as positive values, and a south latitude and a west longitude are expressed as negative values.

FIG. 19 is a view showing an example of the data structure and data of a selection target region input by the selection target range input unit 103. The data structure of a selection target region is a table format including a latitude and a longitude representing the center point of the target range and the radius from the center point, as indicated by a table 1901. The region according to this embodiment is circular. The position of the center of the region is assigned by the items of the latitude and the longitude. The value of the radius of the circle is assigned by the item of the radius. The unit of the radius is km. Note that a method of inputting a range by the selection target range input unit 103 is the same as in the first embodiment, and a description thereof will be omitted.

FIG. 21 is a conceptual view showing the relationship between the image group information described in the table 1801 shown in FIG. 18 and the selection target region described in the table 1901 shown in FIG. 19.

Referring to FIG. 21, image groups 2103 to 2106 are arranged on a map 2101. The image groups 2103 to 2106 correspond to group IDs group1 to group4 in the table 1801 shown in FIG. 18, respectively. The circles of the image groups 2103 to 2106 displayed on the map 2101 contain the positions of images included in the image groups. The circles of the image groups 2103 to 2106 are defined as the capturing regions of the image groups.

A method of obtaining a containing circle that contains the positions of a plurality of images will be described. First, the center of gravity of the plurality of positions is decided as the center of the circle. Next, as for the radius of the circle, the position of an image most distant from the center point of the circle is identified, and the distance is set as the radius of the circle. A selection target region 2102 is a selection target region input from the selection target range input unit 103. The image group 2103 is divided into two regions, that is, portions 2107 and 2108 by the selection target region 2102. The divided regions are the portion 2107 outside the selection target region and the portion 2108 within the selection target region.

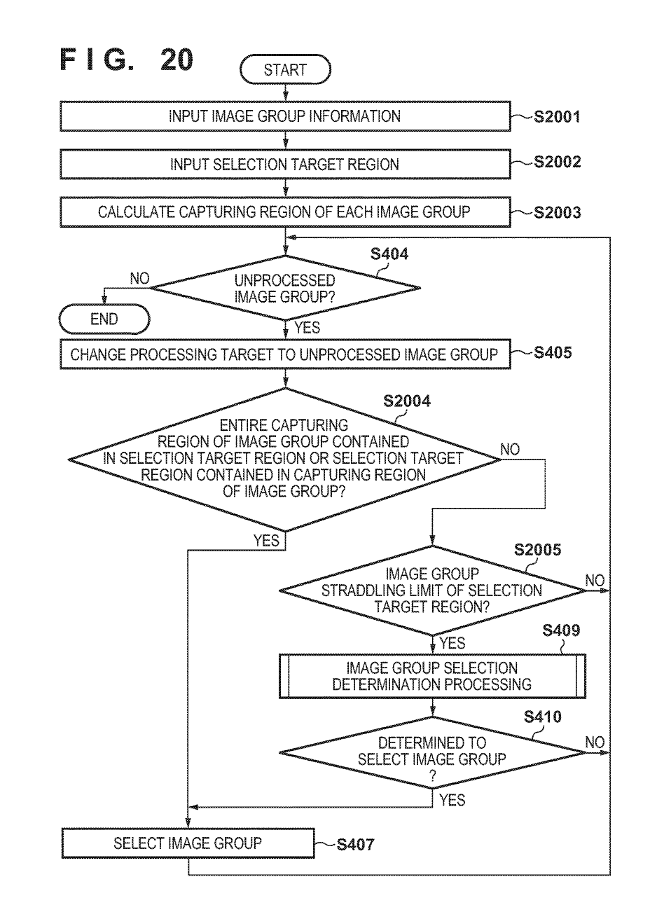

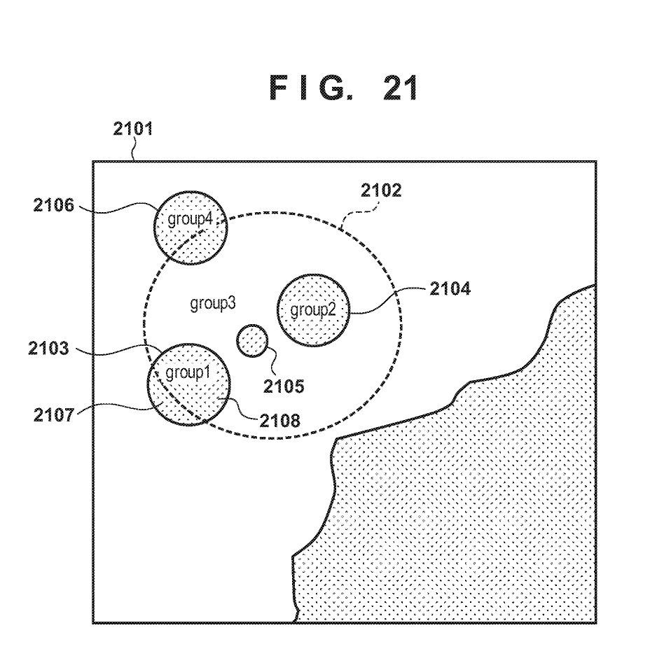

The operation of the image group selection unit 104 according to this embodiment will be described next. FIG. 20 is a flowchart showing the operation of the image group selection unit 104 according to this embodiment. The steps of FIG. 20 are the same as in FIG. 4 described in the first embodiment except steps S401 to S403, S406, S408, and S409. Hence, the difference will be described here.

In step S2001, the image group selection unit 104 accepts input of image group information of the table 1801 from the image group information input unit 102. Here, assume that the information shown in FIG. 18 is input.

In step S2002, the image group selection unit 104 accepts input of the information of a selection target region from the selection target range input unit 103. Here, assume that the information shown in FIG. 19 is input.

In step S2003, the image group selection unit 104 identifies the capturing region of each image group based on the image group information input from the image group information input unit 102. The processing of calculating the capturing region of each image group in step S2003 is the above-described processing of obtaining a containing circle containing the positions of a plurality of images belonging to each image group. Note that in the table 1801 shown in FIG. 18, the image group of the group ID “group3” includes one image, and the containing circle is calculated as a circle having a radius of 0. Hence, in this embodiment, if the radius of a circle is 0, a circle with a radius of 1 m is set. Note that the distance added to the capturing region for the image group including only one image may be another unit distance.

In step S2004, the image group selection unit 104 determines whether the entire capturing region of the image group of the processing target is contained in the selection target region or the entire selection target region is contained in the capturing region of the image group. If one of the conditions is met (YES in step S2004), the process advances to step S407. Otherwise (NO in step S2004), the process advances to step S2005.

In step S2005, the image group selection unit 104 determines whether the capturing region of the image group of the processing target straddles the limit of the selection target region. If the capturing region straddles the limit (YES in step S2005), the process advances to step S409. Otherwise (NO in step S2005), the process returns to step S404. An image group whose capturing region straddles the limit of the selection target region indicates an image group whose capturing region is divided by the selection target region 2102, like the image groups 2106 and 2107 shown in FIG. 21.

The flowchart of image group selection determination processing according to this embodiment has the same processing procedure as that shown in FIG. 5. However, unlike the contents described in the first embodiment, in step S501, the section within the selection target period changes to the size of the portion within the selection target region, and the section outside the selection target period changes to the size of the portion outside the selection target region. Hence, in step S501, the image group selection unit 104 calculates the sizes of the portion within the selection target region and the portion outside the selection target region for the image group of the processing target. If the size of the portion within the selection target region is larger than the size of the portion outside the selection target region (YES in step S501), the process advances to step S502. Otherwise (NO in step S501), the processing procedure ends.

With the above-described arrangement, an image group in which the size of the portion within the selection target region is larger than the size of the portion outside the selection target region in the set selection target region is selected. It is therefore possible to select an image group close to user's intention.

### Eighth Embodiment

In this embodiment, a case in which a period in the second embodiment is changed to a region will be described.

In the second embodiment, in step S802 of FIG. 8, for the image group of the processing target, the number of images belonging to the section within the selection target period out of the capturing region of the image group is compared with the number of images belonging to the section outside the selection target period. If the number of images in the section within the selection target period is larger than the number of images in the section outside the selection target period, the image group is selected.

On the other hand, in this embodiment, in the capturing region of an image group of the processing target, the number of images in the portion within the selection target region is compared with the number of images in the portion outside the selection target region. If the number of images in the portion within the selection target region is larger, the image group is selected. The same effect as in the second embodiment can thus be obtained.

Even if a period in the third to sixth embodiments is changed to a region, the same effect as in these embodiments can be obtained.

More specifically, in the third embodiment, in image group selection determination processing, that is, in step S1001 of FIG. 10, it is evaluated whether the attribute of an image group of a processing target is “travel”. If the attribute of the image group is travel, the image group is selected. Even if a period is changed to a region, the same processing can be applied.

In the fourth embodiment, for an image group straddling the limit of a selection target period, the selection history of each image included in the image group is evaluated, and the presence/absence of image group selection is determined based on the evaluation result. Even if a period is changed to a region, the same processing can be applied.

In the fifth embodiment, if an image group straddling the limit of a selection target period exists, the user is notified of it. Even if a period is changed to a region, the same processing can be applied.

In the sixth embodiment, in step S1701 of FIG. 17, it is evaluated whether the capturing period of an image group is equal to or more than a threshold. If the capturing period of the image group is equal to or more than the threshold, in step S1702, the image group is divided, a group ID is set again for the section within the selection target period, and the image group is selected. On the other hand, in step S1701 of FIG. 17, it is evaluated whether the size of the capturing region of an image group is equal to or more than a threshold. If the size of the capturing region of the image group is equal to or more than the threshold, in step S1702, the image group is divided, a group ID is set again for the portion within the selection target region, and the image group is selected. The same effect as in the sixth embodiment can thus be obtained.

### Ninth Embodiment

In this embodiment, an arrangement concerning a photobook creation apparatus for creating a photobook using the image group selection apparatus 101 described in one of the first to eighth embodiments will be explained.

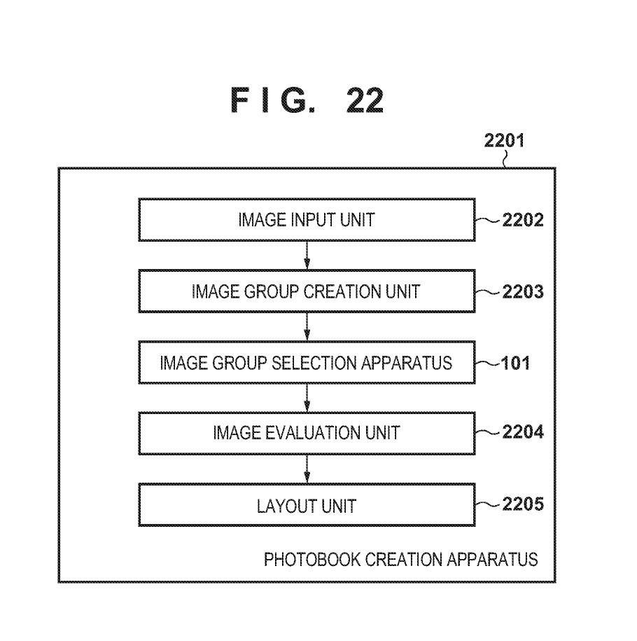

FIG. 22 is a block diagram showing the arrangement of a photobook creation apparatus 2201 according to this embodiment. The photobook creation apparatus 2201 according to this embodiment includes an image input unit 2202, an image group creation unit 2203, the image group selection apparatus 101 described in the first embodiment, an image evaluation unit 2204, and a layout unit 2205. The image input unit 2202 inputs candidate images such as an image captured by the user to be used to create a photobook. The image group creation unit 2203 divides the images into image groups based on the capturing dates/times of the images input by the image input unit 2202, and assigns the group ID of an image group to each image. The image evaluation unit 2204 evaluates each image belonging to each image group selected by the image group selection apparatus 101. The layout unit 2205 selects an image based on the evaluation value of each image evaluated by the image evaluation unit 2204, and lays out it on a page of a photobook.

Note that the photobook creation apparatus 2201 may be formed from one apparatus or a plurality of apparatuses. An example has been described in which the image group selection apparatus 101 explained in the first embodiment is formed from one information processing apparatus. However, as an information processing apparatus including this function, the photobook creation apparatus 2201 may be formed from one apparatus. In this embodiment, the hardware arrangement of the photobook creation apparatus 2201 is the same as that shown FIG. 1B.

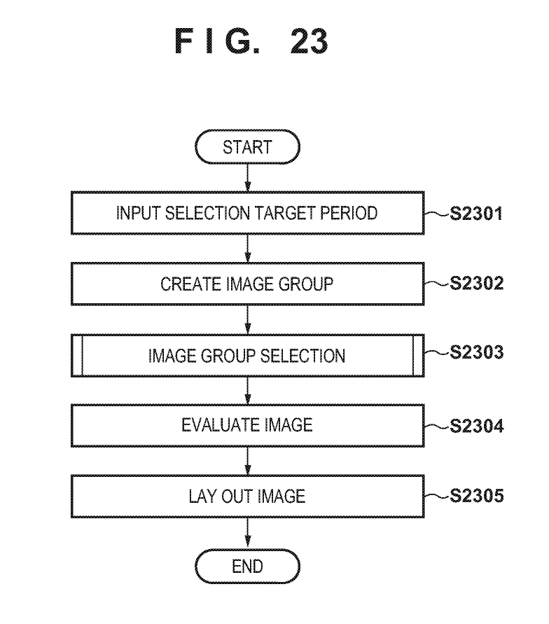

FIG. 23 is a flowchart showing the operation of the photobook creation apparatus 2201 according to this embodiment. This processing procedure is implemented when a CPU provided in the photobook creation apparatus 2201 reads out and executes a program stored in a storage unit such as an HDD.

In step S2301, the image input unit 2202 inputs images of a processing target to the image group creation unit 2203. The image input unit 2202 also inputs a period desired by the user to create a photobook to the image group selection apparatus 101 as a “selection target period”.

In step S2302, the image group creation unit 2203 creates image groups from the images input from the image input unit 2202 based on the capturing date/time of each image. The input images correspond to the table 201 shown in FIG. 2. The image group creation unit 2203 issues group IDs group1 to group4 described as group IDs in the table 201 shown in FIG. 2, and adds them to the table 201.

In step S2303, the image group selection apparatus 101 accepts input of image group information created by the image group creation unit 2203, and performs image group selection processing. The image group selection apparatus 101 also acquires the information of the selection target period input by the user in step S2301. Details of the image group selection processing correspond to the processing shown in FIG. 4.

In step S2304, the image evaluation unit 2204 sets an evaluation value for each image belonging to the image group selected by the image group selection apparatus 101. The evaluation value of each image is set based on the contrast, brightness, or the like of the image. In addition, the “selection target period” input in step S2301 is compared with the capturing time of each image. The evaluation of an image outside the selection target period is lowered. This is because it is assumed that the degree of importance of an image outside the selection target period is often lower than within the selection target period. The rate of lowering the evaluation may be preset to, for example, 10%. This makes it possible to select an image within the selection target period with more preferentially than an image outside the selection target period.

In a case in which an image group includes a few images, the number of images laid out on one page of the photobook may be small if only the images within the selection target period are selected. In this case, when the images outside the selection target period are used as well, images in a number necessary for one page of the photobook can readily be collected.

In step S2305, the layout unit 2205 selects images using the information of the evaluation value of each image set by the image evaluation unit 2204, and lays out the images on each page of the photobook. As for the image selection by the layout unit 2205, a predetermined number of images are selected in descending order of image evaluation value and arranged on each page. The layout processing of the layout unit 2205 may be performed using, for example, a page template in addition to the evaluation values (evaluation results). After that, the processing procedure ends.

Note that the photobook creation apparatus according to this embodiment has been described as an example, the present invention is also applicable to another image content creation apparatus. More specifically, the apparatus is usable to create a slide show. When the photobook creation apparatus 2201 according to this embodiment is used to create a slide show, the layout destination of the layout unit 2205 is not a page but a screen.

With the above-described arrangement, it is therefore possible to create a content close to user's intention using the image group selection apparatus 101 described in one of the first to eighth embodiments.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-157505, filed Aug. 7, 2015, which is hereby incorporated by reference herein in its entirety.

What is claimed is:

1. An information processing method comprising:
inputting information of an image group to which one or more of images belong;
setting a target range when selecting an image group;
if a range identified by the information of the image group input in the inputting straddles a limit of the target range, determining based on the information of the image group and the target range whether to select the image group as an output target candidate; and
selecting one or more image groups corresponding to the target range as the output target candidate, in accordance with the determination.

2. The method according to claim 1, wherein in the determining, if the range identified by the information of the image group is contained in the target range, or the target range is contained in the range identified by the information of the image group, it is determined to select the image group.

3. The method according to claim 1, wherein in the determining, if the range identified by the information of the image group straddles the limit of the target range, a range within the target range with respect to the limit out of the range identified by the information of the image group is compared with a range outside the target range with respect to the limit, and if the range within the target range with respect to the limit is larger, it is determined to select the image group.

4. The method according to claim 1, wherein in the determining, if the range identified by the information of the image group straddles the limit of the target range, the number of images belonging to a range within the target range with respect to the limit out of the range identified by the information of the image group is compared with the number of images belonging to a range outside the target range with respect to the limit, and if the number of images belonging to the range within the target range with respect to the limit is larger, it is determined to select the image group.

5. The method according to claim 1, wherein in the determining, if the range identified by the information of the image group straddles the limit of the target range, it is determined to select the image group when the image group has a predetermined attribute.

6. The method according to claim 5, wherein the predetermined attribute represents a predetermined event in which an image is captured.

7. The method according to claim 1, wherein in the determining, if the range identified by the information of the image group straddles the limit of the target range, whether to select the image group is determined based on one of a selection history of the image group and a selection history of an image belonging to the image group.

8. The method according to claim 1, wherein in the determining, if the range identified by the information of the image group straddles the limit of the target range, it is determined whether the range identified by the information of the image group is larger than a predetermined threshold, and if the range is larger than the threshold, an image belonging to a range within the target range with respect to the limit out of the range identified by the information of the image group is selected as a new image group.

9. The method according to claim 1, further comprising if the range identified by the information of the image group straddles the limit of the target range, notifying a user and accepting a selection instruction,
wherein in the determining, whether to select the image group is determined based on the instruction.

10. The method according to claim 1, wherein the target range set in the setting is a period, and
the range identified by the information of the image group is a range of a date/time at which an image belonging to the image group was captured.

11. The method according to claim 1, wherein the target range set in the setting is a region, and
the range identified by the information of the image group is a range of a position at which an image belonging to the image group was captured.

12. The method according to claim 11, wherein the region as the target range is set by a latitude and a longitude of a center point and a radius from the center point.

13. The method according to claim 1, further comprising outputting the one or more images included in the one or more image groups selected as the output target candidate in the selecting.

14. The method according to claim 13, wherein in the outputting, the one or more images are output to a display device and displayed.

15. The method according to claim 13, wherein in the outputting, the one or more images are output to a printing device and printed.

16. The method according to claim 13, further comprising:
evaluating one or more images belonging to the image group selected in the selecting; and
based on an evaluation result in the evaluating, laying out the one or more images belonging to the image group selected in the selecting,
wherein in the outputting, the one or more images laid out in the laying out are output.

17. An information processing apparatus comprising:
an input unit configured to input information of an image group to which one or more images belong;
a setting unit configured to set a target range when selecting an image group;
a determination unit configured to, if a range identified by the information of the image group input by the input unit straddles a limit of the target range, determine based on the information of the image group and the target range whether to select the image group as an output target candidate; and
a selection unit configured to select one or more image groups corresponding to the target range as the output target candidate, in accordance with the determination by the determination unit.

18. A non-transitory computer-readable storage medium storing a program that causes a computer to function as:
an input unit configured to input information of an image group to which one or more images belong;
a setting unit configured to set a target range when selecting an image group;
a determination unit configured to, if a range identified by the information of the image group input by the input unit straddles a limit of the target range, determine based on the information of the image group and the target range whether to select the image group as an output target candidate; and
a selection unit configured to select one or more image groups corresponding to the target range as the output target candidate, in accordance with the determination by the determination unit.
